(19) United States
(12) Patent Application Publication
(10) Pub. No.: US 2025/0125507 A1
(43) Pub. Date: Apr. 17, 2025

(54) ENERGY STORAGE CELL

(71) Applicant: Carl Freudenberg KG, Weinheim (DE)

(72) Inventors: Peter KRITZER, Forst (DE); Ingo STEPHAN, Rimbach (DE); Michael MUELLER, Bowling Green, OH (US); Raymond SZPARAGOWSKI, Bowling Green, OH (US); Guenter FREY, Schliengen (DE)

(21) Appl. No.: 18/833,419

(22) PCT Filed: Jan. 3, 2023
(86) PCT No.: PCT/EP2023/050073

§ 371 Date: Jul. 26, 2024

(30) Foreign Application Priority Data
Jan. 31, 2022 (DE) 10 2022 102 151.3
Feb. 16, 2022 (DE) 10 2022 103 635.9

(51) Int. Cl. H01M 50/591; D04H 1/413; D04H 1/4291; D04H 1/4334; D04H 1/435; D04H 1/4374; D04H 1/4382; D04H 1/541; D04H 1/542; D04H 1/544; D04H 1/558; D04H 1/56; H01M 10/653; H01M 50/586

(52) U.S. Cl. CPC H01M 50/591; D04H 1/413; D04H 1/4291; D04H 1/4334; D04H 1/435; D04H 1/4374; D04H 1/43828; D04H 1/43835; D04H 1/5412; D04H 1/542; D04H 1/544; D04H 1/558; D04H 1/56; H01M 10/653; H01M 50/586; D10B 2321/021; D10B 2321/022; D10B 2505/00

(57) ABSTRACT

An energy storage cell, including at least one electrode/separator assembly received in a housing. The energy storage cell further includes a covering. The covering is disposed at least in some regions between the electrode/separator assembly and the housing. The covering is made of porous material. The porous material of the covering is open-cell.

### CROSS REFERENCE TO RELATED APPLICATIONS

This application is a U.S. National Phase application under 35 U.S.C. § 371 of International Application No. PCT/EP2023/050073, filed on Jan. 3, 2023, and claims benefit to German Patent Application No. DE 10 2022 102 151.3, filed on Jan. 31, 2022, and German Patent Application No. DE 10 2022 103 635.9 filed on Feb. 16, 2022. The International Application was published in German on Aug. 3, 2023 as WO 2023/143879 A1 under PCT Article 21 (2).

### FIELD

The invention relates to an energy storage cell including at least one electrode/separator assembly which is received in a housing.

### BACKGROUND

Energy storage systems, in particular rechargeable batteries for electrical energy, are widely used, particularly in mobile systems. Rechargeable batteries for electrical energy are used, for example, in portable electronic devices, such as smartphones and laptops. Furthermore, rechargeable batteries for electrical energy are increasingly used for providing energy for electrically powered vehicles. A great variety of electrically powered vehicles is conceivable, such as bicycles, vans, or trucks, in addition to passenger cars. Applications in robots, ships, aircraft, and mobile machines are also conceivable. Further fields of use of electrical energy storage systems are stationary applications, such as in backup systems, in grid stabilization systems, and for the storage of electrical energy from renewable energy sources.

A frequently used energy storage system is a rechargeable battery in the form of a lithium-ion battery. Lithium-ion batteries, just like other rechargeable batteries for electrical energy, generally have a plurality of battery cells, which are installed together in a housing. Usually, a plurality of electrically interconnected battery cells are combined to form a module.

The energy storage system is not limited to lithium-ion batteries. Other rechargeable battery systems, such as lithium-sulfur batteries, solid-state batteries, sodium-ion batteries, or metal-air batteries are conceivable energy storage systems. Furthermore, supercapacitors are also possible energy storage systems.

Energy storage systems in the form of rechargeable batteries have the highest electrical storage capacity and the best power input and output only within a limited temperature spectrum. At temperatures above or below the optimum operating temperature range, the storage capacity, the power intake capacity, and the power output capacity of the storage battery drop sharply, and the functionality of the storage battery is negatively affected. In addition, excessive temperatures can irreversibly damage the storage battery. Therefore, both elevated temperatures over extended periods of time and brief temperature peaks should be avoided at all costs. In the case of lithium-ion batteries, for example, temperatures higher than 50° C. over extended periods of time and brief temperature peaks of more than 80° C. should not be exceeded.

In the case of applications in passenger cars, in particular, fast charging capability of the energy storage systems is required. The storage batteries forming an energy storage system are desired to be charged completely or almost completely within a short period of time, such as within 15 minutes. Since the efficiency of the charging system is about 90% to 95%, large amounts of heat are released during the charging process in the energy storage system and must be removed therefrom. These amounts of heat are not released during normal operation. It is therefore necessary to design the cooling system of the energy storage system such that the amount of heat arising during the charging process can be absorbed.

Excessive temperatures can lead to irreversible damage of the energy storage system. In this context, so-called thermal runaway is known, particularly in connection with lithium-ion cells. During a thermal runaway, large amounts of thermal energy and gaseous decomposition products are released within a short period of time, resulting in high pressure and high temperatures in the housing. This effect is problematic, especially in the case of energy storage systems with high energy density, such as is needed, for example, for providing electrical energy in electrically powered vehicles. Due to increasing amounts of energy of the individual cells and the increasing packing density of the cells arranged in the housing, the problem of thermal runaway is aggravated.

In the region of a cell that is running away, temperatures in the range of from 600° C. to 1,000° C. can arise over a period of several minutes. The device for thermal insulation must withstand such stress and reduce the energy transfer to neighboring cells such that the thermal load on the neighboring cells is only about 150° C. It is essential to limit the energy transfer to neighboring cells in order to prevent them from also thermally running away.

In particular in the field of electric mobility, there is a need to achieve high energy density in a small space, which, however, limits the space available for the insulation of the cells. To prevent individual battery cells from being subjected to excessive thermal loads, it is also necessary to dissipate the heat released by the battery cell. Therefore, it is generally not sufficient to just insulate the battery cells.

It is essential to ensure thermal equalization between the wall of the housing and the electrode/separator assembly. In this process, heat generally flows from the warmer electrode/separator assembly to the cooler wall of the housing, which may also be cooled directly. The problem here is that an electrically insulating layer is usually arranged between the two components, for example a plastic film, which often has a low thermal conductivity. In addition, gas bubbles may accumulate inside the housing during assembly, creating an insulating gas blanket, which greatly restricts heat transfer.

Lithium-ion battery cells are subject to a volume change over their lifetime, the volume increasing with increasing lifetime. In the case of pouch cells, for example, this manifests itself as outward bulging. In addition, cyclic volume changes occur during each charging or discharging process. The volume changes of the battery cells must be compensated for by the device. This is achieved either by clamping the battery cells against each other, which is accompanied by a very substantial increase in pressure. Alternatively, compression elements are arranged between the battery cells, which compression elements accommodate the volume changes of the battery cells.

The thermally insulating effect of the devices known from the prior art decreases with increasing compression. The heat transfer is generally inversely proportional to the distance between the battery cells.

### SUMMARY

In an embodiment, the present disclosure provides an energy storage cell, comprising at least one electrode/separator assembly received in a housing and a covering disposed at least in some regions between the electrode/separator assembly and the housing, the covering being made of porous material.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates an energy storage cell in a partially sectional view;

FIG. 2 illustrates an energy storage cell in the form of a prismatic cell;

FIG. 3 illustrates an energy storage cell in the form of a pouch cell;

FIG. 4 illustrates an energy storage cell in the form of a cylindrical cell;

FIG. 5 illustrates an energy storage cell in a sectional view; and

FIG. 6 illustrates a covering in a sectional view.

### DETAILED DESCRIPTION

In an embodiment, the present invention provides an energy storage cell that exhibits improved usage characteristics.

An energy storage cell according to an embodiment of the invention includes at least one electrode/separator assembly which is received in a housing, a covering being disposed at least in some regions between the electrode/separator assembly and the housing, the covering being made of porous material.

By making the covering from porous or pore-containing material, the covering can be designed to have elastic insulating and electrically insulating properties. The term “elastic,” as used in the context of the present disclosure, is understood to also mean reversibly deformable. However, the covering is also designed to provide both electrical insulation and thermal conductivity.

The material can be open-cell. In this embodiment, it is advantageous that the covering is capable of receiving a liquid, in particular an electrolyte, which at least partially fills the region between the electrode/separator assembly and the housing.

Preferably, the covering is elastic. This allows the covering to compensate for cyclic volume changes of the electrode/separator assembly, which can result from different charge states and can also be due to the life cycle of the electrode/separator assembly. Due to the deformability, the increase in the volume of the electrode/separator assembly can be compensated for during filling with the electrolyte. As mentioned previously, “elastic” is understood to also mean reversibly deformable.

In the area of the end faces of the electrode/separator assembly, the covering can also be configured as an end cover. In this connection, the deformable properties can compensate for tolerances of the electrode/separator assembly resulting from the manufacturing process.

The covering can be formed from a fibrous structure. More particularly, the covering can be formed from a planar textile structure, a paper-like material, or the like. In an advantageous embodiment, the covering is formed from a nonwoven fabric. Nonwoven fabrics are planar textile structures which can be designed to have an optimized porosity, elasticity, and deformability for the technical function of the covering and to ensure the function of electrical insulation. Due to their fiber-based structure, nonwoven fabrics have a high mechanical strength, which can be enhanced by additional measures.

For example, the mechanical strength can be improved by thermofixation, during which fiber intersection points are fused together.

Nonwoven fabrics have high tear propagation resistance and are resistant to particle penetration. Such particles can result, for example, from processing errors in cell production. If electrically conductive particles penetrate the covering, an electrical short circuit can occur between the electrodes and the wall of the housing. The use of a nonwoven fabric is advantageous in that such particles can be embedded in the matrix of the fiber structure without the formation of cracks. Due to the fiber structure, nonwoven fabrics exhibit reversible compressibility, which, in the case of the covering according to embodiments of the invention, is preferably in the range of 30%. Such compressibility assists in the volume compensation of the electrode/separator assembly throughout all charge states and also in the case of age-related thickness growth.

For example, for a covering thickness of 120 μm and a compressibility of 30%, it is possible to compensate for thickness variations in the range of 35 μm on each side, or a total of 70 μm. Thus, the covering can accommodate typical thickness variations of electrode/separator assemblies within the energy storage cell and reduce mechanical compression of the electrode/separator assembly.

Through-holes (pinholes) can be avoided if the fiber arrangement is highly homogeneous, if the fibers of the fiber arrangement have a small fiber diameter, if the porosity is selected so as not to be too high, or if many layers are implemented across the thickness of the covering.

The covering can be formed from a wet-laid nonwoven fabric. Wet-laid nonwoven fabrics have the particular advantage of having a particularly homogeneous and smooth surface. This is advantageous, especially at the surface facing the electrode/separator assembly because the homogeneous surface can prevent the occurrence of local pressure peaks, which can lead to cell damage in the long term. In this context, it is particularly advantageous that if the covering is mechanically deformable, the homogeneities of the electrode/separator assembly can be compensated for.

For example, local outward bulges, which can occur in the case of local aging phenomena, can be compensated for by the covering.

The fibrous structure can include plastic fibers, glass fibers, and/or ceramic fibers. These fibers are electrically insulating.

Alternatively, the covering can be formed from a spunbond nonwoven fabric. In particular, meltblown/spunbond nonwoven fabrics can be used. Thanks to the manufacturing process, spunbond nonwoven fabrics have particularly low levels of contamination, which reduces the risk of contamination entering the energy storage cell.

It is provided that the covering from a dry-laid nonwoven fabric can be formed. Dry-laid nonwoven fabrics can particularly readily be manufactured to be anisotropic and therefore are suitable for coverings which are subjected to particularly high mechanical loads in a predominant direction.

Preferably, the porosity of the covering is no more than 70%. This makes it possible to ensure that the covering is electrically insulating. An increase in porosity also results in an increase in compressibility and elasticity. However, it must always be ensured that the covering is electrically insulating and has a certain thermal conductivity.

Preferably, the average pore size is between 3 μm and 40 μm. With such a design, advantageous properties are achieved with respect to electrical insulation, thermal conductivity, and elasticity.

The covering can have a multilayer structure. Preferably, the covering is formed of at least five, preferably at least eight fiber layers. This results in a high mechanical restoring force to assist in the thickness compensation of the electrode/separator assembly. Due to the multilayer structure, it can be ensured that open pores are present even in the maximally compressed state, while ruling out the occurrence of through-pores (pinholes). For example, for a covering thickness of 100 μm, 10 fiber layers with a thickness of 10 μm each can be implemented. In this connection, finer fibers lead to an improvement in homogeneity and a reduction in the risk of through-pores. The fiber structure can be composed of fibers with similar fiber diameters or of a fiber mixture including thicker structural fibers and finer, homogeneity-enhancing fibers. It is also provided that microfibrillated fiber bundles (pulps) are used as a homogeneity-enhancing component.

The porosity of the covering provides an additional reservoir for electrolyte. For a porosity of 50% and a covering thickness of 120 μm, an additional electrolyte volume of about 3.4 cm³ is obtained in an energy storage cell having the dimensions 250×100×30 mm. This additional electrolyte volume can counteract aging processes of the electrode/separator assembly.

The covering can have ceramic particles embedded therein. The ceramic particles can improve the thermal conductivity and also the electrically insulating properties of the covering. Possible particles include, in particular, inorganic particles, such as aluminum oxides, aluminum hydroxides, or silicon dioxides, which are introduced into the interstices between fibers. Ceramic fillers make it possible to produce a thermally stable insulation layer. Thus, even temperatures occurring during thermal runaway of the cell do not lead to the immediate destruction of the covering; electrical insulation is maintained.

An electrolyte can be received in the housing, which electrolyte contacts the covering. Thanks to the pores of the material of the covering, the electrolyte can be received in the covering itself, so that additional electrolyte can be contained in the housing. The electrolyte makes it possible in particular also to improve the thermal conductivity between the electrode/separator assembly and the housing. The advantage of this is that an additional amount of electrolyte can be introduced into the energy storage cell as compared to a closed covering. This additional amount of electrolyte is available as an additional reservoir and results in improved properties, in particular at the end of the life of the energy storage cell.

The material of the covering, in particular the fibrous material of the covering, can be designed to be wettable by an electrolyte disposed in the housing. This can assist in the wetting of the electrode/separator assembly, which is advantageous especially during the filling process. This can be achieved through the selection of the fibrous materials for the covering. For example, polar polymers, such as polyamides or polyesters, are wettable by an electrolyte. When polyolefins are used, hydrophilization processes, such as gas-phase fluorination, plasma treatment, grafting with polar substances (e.g., acrylic acid), or sulfonation, can lead to permanent wettability by the electrolyte. The application of wetting agents is also provided, which, in particular, speeds up the filling process. It is also advantageous that in the case of a wettable covering, gas bubbles are driven out of the cell housing during the filling process. In the case of foil-based coverings, for example, this is not easily possible.

It is advantageous if the covering provides thermal conductivity through the plane. This can improve heat transfer from the electrode/separator assembly through the covering toward the housing. Usually, the temperature of the energy storage cells is controlled from the outside via the housing. Thanks to the thermal conductivity of the covering, an improved thermal management of the electrode/separator assembly can be achieved. The thermal conductivity improves especially when the pores are filled with electrolytes. Electrolytes usually have a relatively high thermal conductivity. In addition, if there is a temperature gradient between a warmer electrode/separator assembly and a cooler housing, a convection-induced circulation of the electrolyte within the porous covering can be achieved, which promotes effective temperature equalization. The circulation increases with increasing temperature difference. Thanks to the fiber scaffold structure of the nonwoven fabric, which still has open pores even in the maximally compressed state, this cooling effect is also effective in aged cells. The thermal conductivity of the electrolyte and the use of convection enable an improved thermal management of the energy storage cell, independently of the possible thermal insulating properties of the fibrous material of the covering.

Advantageously, the covering can be provided with an adhesive surface, which allows the covering to be applied to the electrode/separator assembly during assembly. This eliminates the need for additional adhesive tapes, which can be associated with local thickenings. For example, adhesive surfaces based on acrylate binders can be provided.

The figures show an energy storage cell 1 including at least one electrode/separator assembly 2 which is received in a housing 3. A covering 4 is disposed at least in some regions between electrode/separator assembly 2 and housing 3, the covering 4 being made of pore-containing material.

In the present case, the material is open-cell, the covering 4 being composed of a fibrous structure, specifically of nonwoven fabric. Covering 4 is elastic and has a porosity of no more than 70%. The average pore size is between 3 μm and 40 μm. Covering 4 has ceramic particles embedded therein. The thickness of covering 4 is determined using a probe, which presses onto the surface with a force of 100 kPa. The porosity is calculated from the formula: porosity=(1−A/(B×C×1.000))*100, where A is the weight per unit area in g/m2, B is the density of the material in g/cm³, and C is the thickness.

Housing 3 contains an electrolyte, which contacts covering 4 and is partially received within covering 4.

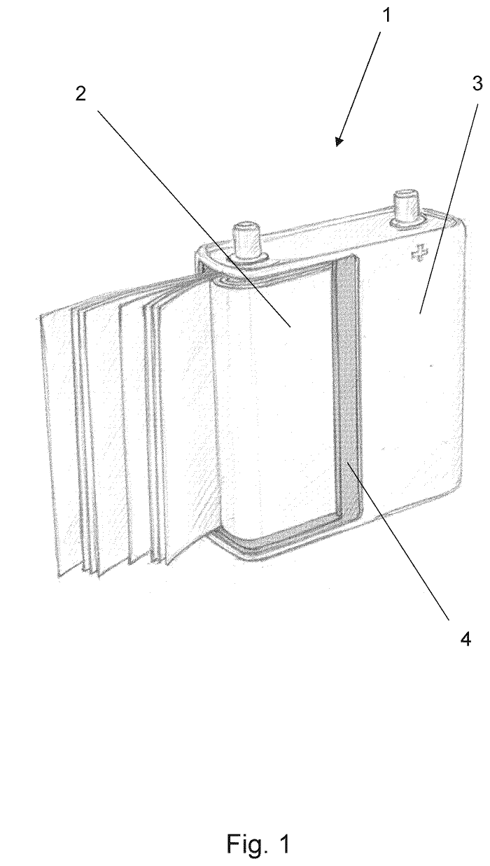

FIG. 1 shows energy storage cell 1 in a partially sectional view. It can be seen that covering 4 is disposed between housing 3 and electrode/separator assembly 2. Covering 4 embeds electrode/separator assembly 2, forms an electrical insulation between housing 3 and electrode/separator assembly 2, creates a thermally conductive connection between housing 3 and electrode/separator assembly 2, and compensates for volume changes of electrode/separator assembly 2 by way of its elasticity. In addition, the bottom region of energy storage cell 1 can also be covered by covering 4.

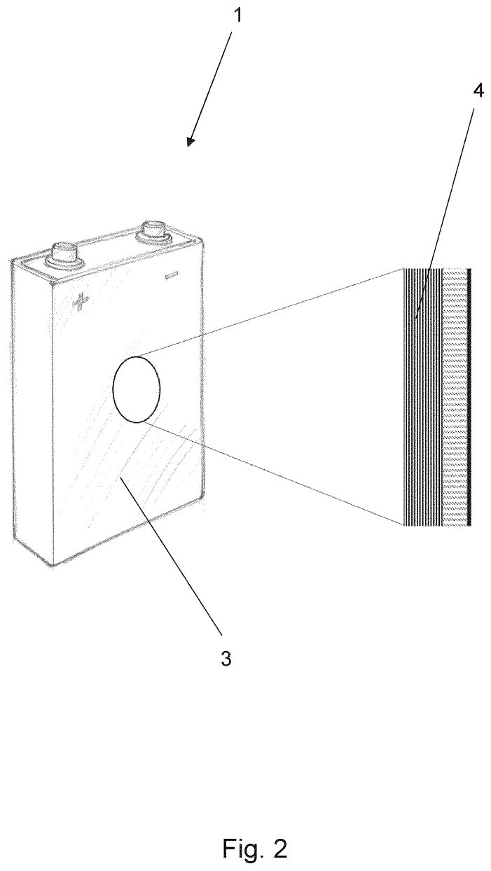

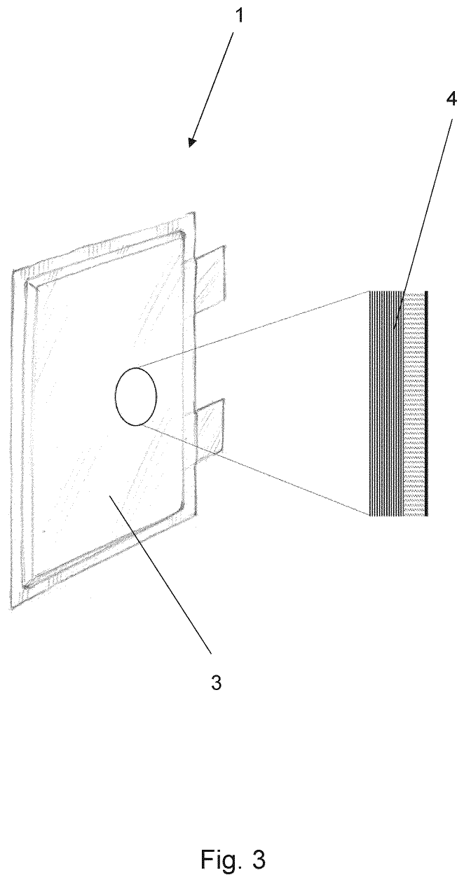

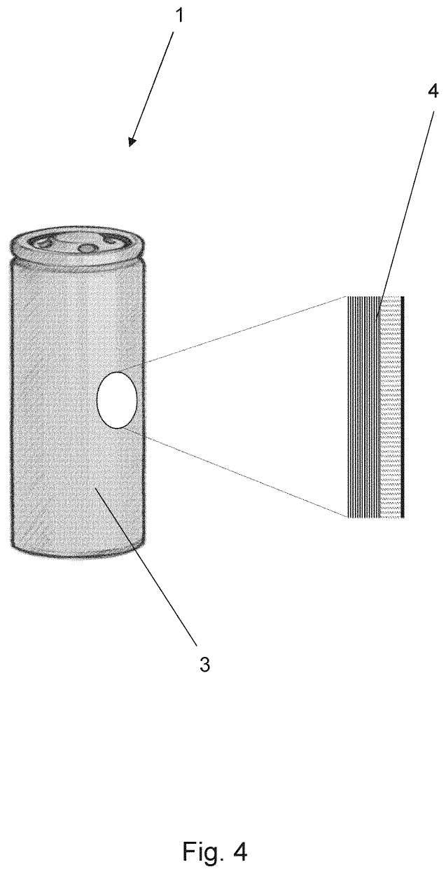

FIG. 2 shows energy storage cell 1 in the form of a prismatic cell. FIG. 3 shows energy storage cell 1 in the form of a pouch cell. FIG. 4 shows energy storage cell 1 in the form of a cylindrical cell.

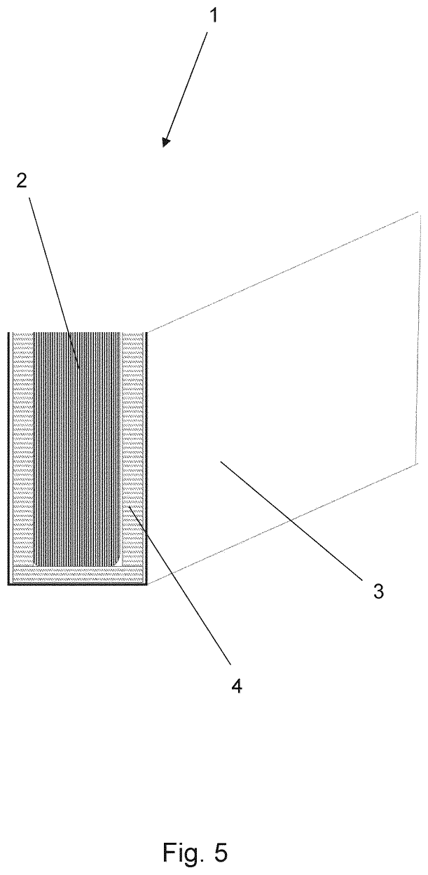

FIG. 5 shows energy storage cell 1 in a sectional view. In this embodiment, covering 4 covers electrode/separator assembly 2 in the region of the sides and in the region of the bottom.

In an alternative embodiment, covering 4 covers electrode/separator assembly 2 in the region of the sides, in the region of the bottom, and in the region of the top cover. The bottom can have an additional bottom member associated therewith, which can be dimensionally stable. The top cover can have an additional top cover member associated therewith The top cover member and/or the bottom member can be arranged between housing 3 and electrode/separator assembly 2. In addition, covering 4 can extend between the bottom member and/or the top cover member and housing 3 and/or electrode/separator assembly 2.

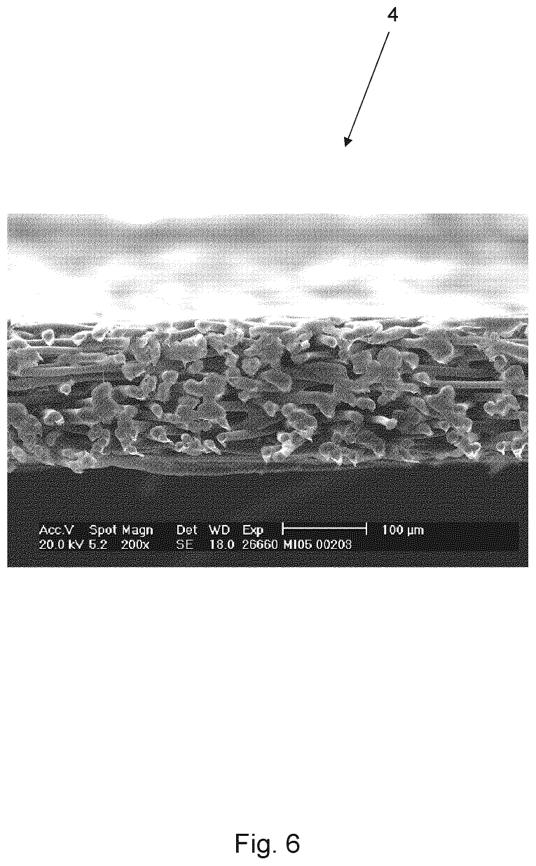

FIG. 6 shows in detail a wall of a covering 4 in a sectional view. In the present embodiment, covering 4 is formed from a nonwoven fabric. The nonwoven fabric can be formed as a meltblown nonwoven fabric or a wet-laid nonwoven fabric. In a first alternative, the nonwoven fabric has a single layer; in a second alternative, the nonwoven fabric has multiple layers, in particular five layers or eight layers. Various embodiments of the nonwoven fabric of covering 4 will be specifically described below.

### 1St Exemplary Embodiment

Provision of a wet-laid polyolefinic nonwoven fabric based on polypropylene and polyethylene with a weight per unit area of 60 g/m2 and a thickness of 120 μm. The air permeability of the wet-laid nonwoven fabric is 220 l/sm2 at a pressure difference of 2 mbar. The wet-laid nonwoven fabric is solidified by thermal bonding and by using core-sheath binder fibers. The use of polyolefins is advantageous, especially with respect to lithium-ion accumulators, because polyolefins are stable relative to the materials of the storage battery. The wet-laid nonwoven fabric is wrapped around electrode/separator assembly 2 so as to form covering 4.

### 2Nd Exemplary Embodiment

Provision of a wet-laid polyolefinic nonwoven fabric based on polypropylene and polyethylene with a weight per unit area of 60 g/m2 and a thickness of 120 μm. The air permeability of the wet-laid nonwoven fabric is 220 l/sm2 at a pressure difference of 2 mbar. The wet-laid nonwoven fabric is solidified by thermal bonding and by using core-sheath binder fibers. The use of polyolefins is advantageous, especially with respect to lithium-ion accumulators, because polyolefins are stable relative to the materials of the storage battery. The surface of the wet-laid nonwoven fabric was made permanently hydrophilic by means of gas-phase fluorination. The use of fluorinated polyolefins is advantageous, especially in connection with use in alkaline cell systems, such as nickel-metal hydride batteries. The wet-laid nonwoven fabric is wrapped around electrode/separator assembly 2 so as to form covering 4.

### 3Rd Exemplary Embodiment

Provision of a wet-laid polyolefin nonwoven fabric based on polypropylene and polyethylene with a weight per unit area of 63 g/m2 and a thickness of 140 μm. The surface of the wet-laid nonwoven fabric was made permanently hydrophilic by means of gas-phase fluorination. The wet-laid nonwoven fabric is wrapped around electrode/separator assembly 2 so as to form covering 4.

### 4Th Exemplary Embodiment

Provision of a wet-laid polyester nonwoven fabric based on polyethylene terephthalate (PET) and polybutylene terephthalate (PBT) with a weight per unit area of 50 g/m2 and a thickness of 95 μm. The air permeability is 500 l/sm2 at a pressure difference of 2 mbar. The material is thermally solidified by thermal bonding and by using core-sheath binder fibers. Compared to polyolefins, polyester-based plastics have a higher temperature resistance. The wet-laid nonwoven fabric is wrapped around electrode/separator assembly 2 so as to form covering 4.

### 5Th Exemplary Embodiment

Provision of a wet-laid polyamide nonwoven fabric based on polyamide 6.6 and polyamide 6. The weight per unit area is 67 g/m2 and the thickness is 120 μm. The material is thermally solidified by thermal bonding and by using core-sheath binder fibers. Polyamides exhibit relatively high swelling in connection with lithium electrolytes. However, in connection with covering 4, this can be advantageous because electrode/separator assembly 2 is thereby embedded in covering 4. The wet-laid nonwoven fabric is wrapped around electrode/separator assembly 2 so as to form covering 4.

### 6Th Exemplary Embodiment

Provision of a meltblown nonwoven fabric based on polypropylene. The weight per unit area is 43 g/m2 and the thickness is 110 μm. Bonding is accomplished by in-situ thermal bonding during fiber placement. The material is then calendered. The wet-laid nonwoven fabric is wrapped around electrode/separator assembly 2 so as to form covering 4.

### 7Th Exemplary Embodiment

Provision of a wet-laid nonwoven fabric based on polyphenylene sulfide (PPS). The weight per unit area is 60 g/m2 and the thickness is 105 μm. Thermal bonding is carried out by calendering. The wet-laid nonwoven fabric is wrapped around electrode/separator assembly 2 so as to form covering 4.

### 8Th Exemplary Embodiment

Provision of a wet-laid polyolefinic nonwoven fabric containing core-sheath binder fibers having a core of polypropylene and a sheath of polyethylene. The fiber mixture of core and sheath fibers additionally contains a highly fibrillated polypropylene pulp. The nonwoven fabric formed therefrom has a weight per unit area of 55 g/m2 and a thickness of 110 μm. The air permeability of the wet-laid nonwoven fabric is 180 l/sm2 at a pressure difference of 2 mbar. The wet-laid nonwoven fabric is solidified by thermal bonding, without the highly fibrillated pulp fusing together at the solidification temperatures. The wet-laid nonwoven fabric is wrapped around electrode/separator assembly 2 so as to form covering 4.

### 9Th Exemplary Embodiment

Provision of a spunbond nonwoven fabric based on polyethylene terephthalate (PET) with a weight per unit area of 70 g/m2 and a thickness of 130 μm. Solidification is accomplished by thermal bonding by means of calendering. The spunbond nonwoven fabric is wrapped around electrode/separator assembly 2 so as to form covering 4. Spunbond nonwoven fabrics are advantageous for the present application because they can be produced in a clean process protected from contamination.

### 10Th Exemplary Embodiment

Provision of a spunbond nonwoven fabric based on polyethylene terephthalate (PET) and a copolymer of polyethylene terephthalate (coPET) in the form of core-sheath fibers. The nonwoven fabric has a weight per unit area of 80 g/m2 and a thickness of 140 μm. Solidification is accomplished by thermal bonding by means of calendering. The spunbond nonwoven fabric is wrapped around electrode/separator assembly 2 so as to form covering 4.

### 11Th Exemplary Embodiment

Provision of a spunbond nonwoven fabric based on polypropylene (PP). The nonwoven fabric has a weight per unit area of 60 g/m2 and a thickness of 100 μm. Solidification is accomplished by thermal bonding by means of calendering. The spunbond nonwoven fabric is wrapped around electrode/separator assembly 2 so as to form covering 4.

### 12Th Exemplary Embodiment

Provision of a dry-laid nonwoven fabric based on polyethylene terephthalate (PET) with a weight per unit area of 60 g/m2 and a thickness of 85 μm. Solidification is accomplished by thermal bonding by means of calendering. The dry-laid nonwoven fabric is wrapped around electrode/separator assembly 2 so as to form covering 4.

In other embodiments, nonwoven fabrics based on glass fibers or fabrics made of silicate fibers are used. In addition to fibers, covering 4 can contain fibrillated fillers (pulp). These reduce the pore diameters and at the same time increase the surface area of covering 4.

The aforedescribed materials have a relatively low porosity and a homogeneous pore structure. This is achieved by a high and defined compression of the material during thermal bonding or during calendering. Also used are fibers having a small fiber diameter of between 1 μm and 15 μm. Producing the covering 4 by wet-laying or meltblowing processes makes it possible to obtain a particularly uniform nonwoven structure.

In order form covering 4, the material can be in the form of a strip-shaped layer that is wrapped around electrode/separator assembly 2.

The width of the layer is approximately equal to the height of electrode/separator assembly 2.

In the case of inserted electrode/separator assemblies 2, which are used in particular in pouch cells or prismatic cells, it is also provided that covering 4 can be in the form of cover layers on both sides of electrode/separator assembly 2.

It is also provided that covering 4 can be attached to sides of electrode/separator assembly 2 that have terminal feed-throughs. In this case, penetrations can be formed in covering 4 in the area of the terminal feed-throughs.

Covering 4 can be attached to a bottom plate. Bottom plates can be all-over plastic components provided with cutouts, scaffold-like plastic components, or also nonwoven-based structures. If there is a rupture opening in the cell housing in the area of the bottom plate, it is advantageous to provide a corresponding cutout in the bottom plate at this location. In principle, it is also provided that ceramic bottom plates are included. In this connection, care must be taken to ensure that electrode/separator assembly 2 is securely fixed in the bottom plate so as to ensure reliable electrical insulation of electrode/separator assembly 2. The attachment of covering 4 to the bottom plate can be accomplished, for example, by adhesive bonding or welding.

Covering 4 can also be attached to a top cover plate. Top cover plates can be all-over plastic components provided with cutouts, scaffold-like plastic components, or also nonwoven-based structures. In principle, it is also provided that ceramic top plates can be included. If there is a rupture opening in the cell housing in the area of the top cover plate, it is advantageous to provide a corresponding cutout in the top cover plate at this location. In this connection, care must be taken to ensure that electrode/separator assembly 2 is securely fixed to the top cover plate so as to ensure reliable electrical insulation of electrode/separator assembly 2. The attachment of covering 4 to the top cover plate can be accomplished, for example, by adhesive bonding or welding.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage cell, comprising:
at least one electrode/separator assembly is received in a housing; and
a covering being disposed at least in some regions between the electrode/separator assembly and the housing, the covering being made of porous material.

2. The energy storage cell as recited in claim 1, wherein the porous material is open-cell.

3. The energy storage cell as recited in claim 1, 2, wherein the covering is elastic.

4. The energy storage cell as recited in claim 1, wherein the covering is formed from a fibrous structure.

5. The energy storage cell as recited in claim 1, wherein the covering is formed from a nonwoven fabric.

6. The energy storage cell as recited in claim 1, wherein the covering is formed from a wet-laid nonwoven fabric, a dry-laid nonwoven fabric, and/or a spunbond nonwoven fabric.

7. The energy storage cell as recited in claim 4, wherein the fibrous structure includes plastic fibers, glass fibers, and/or ceramic fibers.

8. The energy storage cell as recited in claim 1, wherein the porosity of the covering is no more than 70%.

9. The energy storage cell as recited in claim 1, wherein the average pore size is between 3 μm and 40 μm.

10. The energy storage cell as recited in claim 1, wherein the covering has a multilayer structure.

11. The energy storage cell as recited in claim 10, wherein the covering has at least five fiber layers.

12. The energy storage cell as recited in claim 1, wherein the covering has ceramic particles embedded therein.

13. The energy storage cell as recited in claim 1, wherein an electrolyte is received in the housing, which electrolyte contacts the covering.

14. The energy storage cell as recited in claim 13, wherein the porous material of the covering is treated such that the covering is wettable by the electrolyte.

15. The energy storage cell as recited in claim 13, wherein the electrolyte contacts the housing and the electrode/separator assembly.

16. The energy storage cell as recited in claim 13, wherein the electrolyte is capable of configured to be circulated in the covering.

17. The energy storage cell as recited in claim 13, wherein the thermal conductivity of the covering soaked with an electrolyte is at least 0.4 W/(m×K).

18. The energy storage cell as recited in claim 1, wherein the covering is provided with an adhesive layer on a side facing the electrode/separator assembly-.

19. The energy storage cell as recited in claim 1, wherein the covering has a bottom plate and/or a top cover plate associated therewith.

20. The energy storage cell as recited in claim 19, wherein the covering is at least partially laid around the bottom plate and/or the top cover plate.
